(19) United States
(12) Patent Application Publication
(10) Pub. No.: US 2026/0054547 A1
(43) Pub. Date: Feb. 26, 2026

(54) METHOD FOR OPERATING A REFRIGERATION SYSTEM WITH HEAT PUMP FUNCTION FOR A MOTOR VEHICLE BASED ON THE REFRIGERANT MASS FLOW AND REFRIGERATION SYSTEM WITH CONTROL UNIT FOR CARRYING OUT THE METHOD

(71) Applicant: AUDI AG, lngolstadt (DE)

(72) Inventors: Julian CHERCHI, Pollenfeld (DE); Stephan PARZINGER, Karlskron (DE)

(73) Assignee: AUDI AG, lngolstadt (DE)

(21) Appl. No.: 19/301,518

(22) Filed: Aug. 15, 2025

(30) Foreign Application Priority Data
Aug. 26, 2024 (DE) 102024124251.5

(51) Int. Cl. B60H 1/32; B60H 1/00

(52) U.S. Cl. CPC B60H 1/3213; B60H 1/00385; B60H 2001/3238; B60H 2001/3242; B60H 2001/325; B60H 2001/3257

(57) ABSTRACT

A method operating a refrigeration system with a heat pump function for a motor vehicle with an at least partially electric drive. The refrigeration system has a refrigerant compressor; a first heat exchanger; at least one further heat exchanger; a sensor device arranged upstream of the refrigerant compressor on the low-pressure side for detecting a first refrigerant pressure and/or a first refrigerant temperature; a sensor device arranged downstream of the refrigerant compressor on the high-pressure side for detecting a second refrigerant pressure and/or a second refrigerant temperature. The method includes detecting the first refrigerant pressure and/or the first refrigerant temperature; detecting the second refrigerant pressure and/or the second refrigerant temperature; detecting a rotational speed of the refrigerant compressor; determining a refrigerant volumetric efficiency; and determining a refrigerant mass flow based on the refrigerant volumetric efficiency.

### FIELD

The invention relates to a method for operating a refrigeration system with heat pump function for a motor vehicle with at least partially electric drive, wherein the refrigeration system has: a refrigerant compressor; a first heat exchanger, in particular a gas cooler or condenser; at least one further heat exchanger, in particular an evaporator and/or a chiller and/or a heating register; a sensor device arranged on the low-pressure side upstream of the refrigerant compressor for detecting a first refrigerant pressure and/or a first refrigerant temperature; a sensor device arranged on the high-pressure side downstream of the refrigerant compressor for detecting a second refrigerant pressure and/or a second refrigerant temperature.

### BACKGROUND

Various methods for operating refrigeration systems of motor vehicles are known in the prior art. Reference is made, for example, to the following publications: DE 10 2021 132 800 A1, DE 44 322 72 A1, DE 10 2012 222 594 A1, DE 10 2010 061 465 A1.

Complex refrigerant circuits, especially in electrically powered vehicles, have a high number of connection variants. These connections, which can also be referred to as operating modes, result in different load situations and therefore different requirements for refrigerant mass flows. An increase in the refrigerant mass flow, in particular by increasing the speed of the refrigerant compressor, can under certain circumstances lead to a reduction in efficiency without, at the same time, increasing the cooling capacity. This is caused in particular by excessive pressure losses in the components on the low-pressure side or suction side of the refrigeration system. Furthermore, (more complex) refrigeration systems with heat pump function usually have a separate temperature sensor after the evaporator, which leads to increased costs and installation space requirements.

### SUMMARY

The object of the invention is to provide a method for operating a refrigeration system in which the above disadvantages can be avoided.

A method is thus proposed for operating a refrigeration system with heat pump function for a motor vehicle with at least partially electric drive, wherein the refrigeration system has: a refrigerant compressor; a first heat exchanger, in particular a gas cooler or condenser; at least one further heat exchanger, in particular an evaporator and/or a chiller and/or a heating register; a sensor device arranged on the low-pressure side upstream of the refrigerant compressor for detecting a first refrigerant pressure and/or a first refrigerant temperature; a sensor device arranged on the high-pressure side downstream of the refrigerant compressor for detecting a second refrigerant pressure and/or a second refrigerant temperature, wherein the method comprises the following steps:
detecting the first refrigerant pressure and/or the first refrigerant temperature;
detecting the second refrigerant pressure and/or the second refrigerant temperature;
detecting a speed of the refrigerant compressor;
determining a refrigerant volumetric efficiency based on the pressure ratio of the first refrigerant pressure and the second refrigerant pressure and the speed of the refrigerant compressor;
determining a refrigerant mass flow based on the refrigerant volumetric efficiency.

The method may further comprise the step of: determining a low-pressure side density of the refrigerant in a superheated region based on the second refrigerant pressure and the second refrigerant temperature.

The method may further comprise the step of: determining a low-pressure side density of the refrigerant in a wet vapor region based on the second refrigerant pressure.

In the method, an assigned maximum refrigerant mass flow can be used for each operating state of the refrigeration system, in particular cooling operation, heating operation, reheat operation, and the speed of the refrigerant compressor in the respective operating state can be limited depending on the assigned maximum refrigerant mass flow.

Thus, the proposed method can be used to achieve a connection-dependent or operating mode-dependent total mass flow limitation, wherein in particular the sensors usually present in the refrigeration system are used.

The refrigerant mass flow can be calculated, for example, as follows:
mKM=ρKM·λKV·Vhub·nKV with
mKM Refrigerant mass flow
ρKM Density of the refrigerant
λKV Volumetric efficiency of the refrigerant compressor
Vhub Displacement volume of the refrigerant compressor
nKV Speed of the refrigerant compressor

Also proposed is a refrigeration system with heat pump function for a motor vehicle with at least partially electric drive, wherein the refrigeration system comprises: a refrigerant compressor; a first heat exchanger, in particular a gas cooler or condenser; at least one further heat exchanger, in particular an evaporator and/or a chiller and/or a heating register; a sensor device arranged on the low-pressure side upstream of the refrigerant compressor for detecting a first refrigerant pressure and/or a first refrigerant temperature;
a sensor device arranged on the high-pressure side downstream of the refrigerant compressor for detecting a second refrigerant pressure and/or a second refrigerant temperature; and a control unit configured to carry out the method described above.

A motor vehicle with at least partially electric drive, in particular also a purely electric vehicle, can be designed with a refrigeration system as described above, which can be operated in particular according to the method described above.

### BREIF DESCRIPTION OF THE FIGURES

Further advantages and details of the invention will become apparent from the following description of embodiments with reference to the figures. In particular:

FIG. 1 is a simplified and schematic representation of a refrigeration system of a motor vehicle;

FIG. 2 is a simplified representation of a method for operating a refrigeration system.

### DETAILED DESCRIPTION

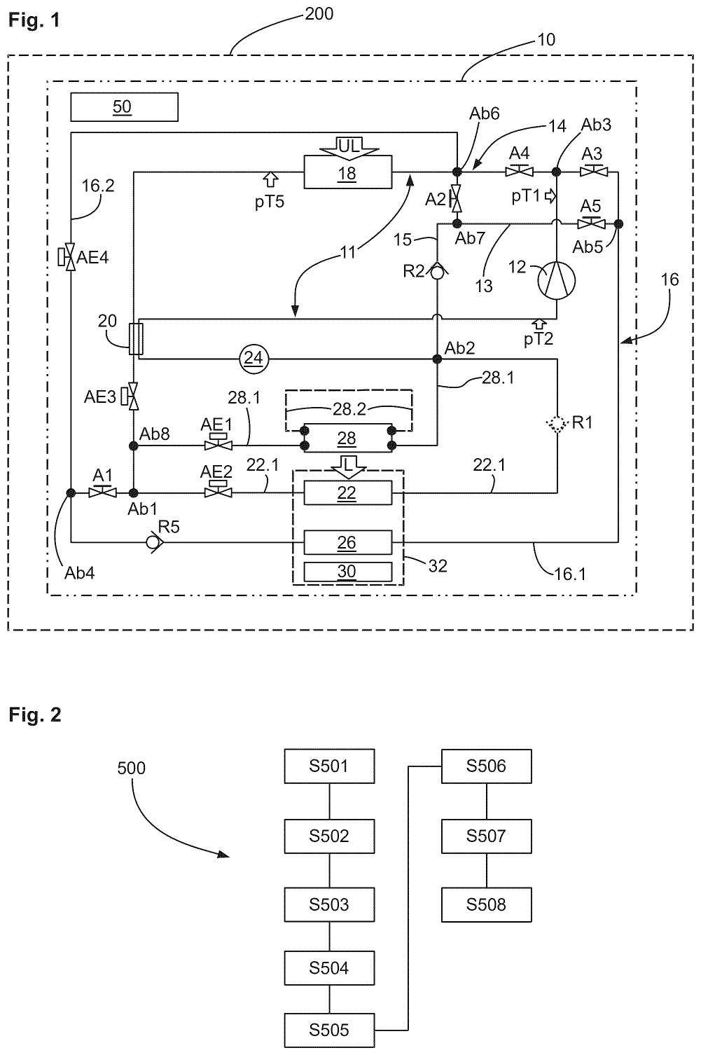

FIG. 1 shows an embodiment of a refrigeration system 10 for a motor vehicle in a schematic and simplified manner. The refrigeration system 10 comprises a refrigerant circuit 11, which can be operated both in a refrigeration system operation (also called AC operation for short) and in a heat pump mode. In the embodiment shown, the refrigeration system 10 comprises a refrigerant compressor 12, an external heat exchanger 18, an internal heat exchanger 20, an evaporator 22 and an accumulator or refrigerant collector 24. The external heat exchanger 18 can be designed as a condenser or gas cooler. In particular, the external heat exchanger 18 in the illustrated embodiment can be flowed through bidirectionally.

The evaporator 22 is shown here by way of example as a front evaporator for a vehicle. The evaporator 22 is also representative of other evaporators possible in a vehicle, for example rear evaporators, which can be arranged fluidically in parallel to one another. In other words, the refrigeration system 10 comprises at least one evaporator 22.

A shut-off valve A4 is arranged downstream of the compressor 12. An expansion valve AE2 is provided upstream of the evaporator 22.

For the purposes of this description, in the entire refrigerant circuit 11 of the refrigeration system 10, the section from the compressor 12 to the external heat exchanger 18, to the internal heat exchanger 20 and to the evaporator 22 is referred to as the primary line 14.

The refrigeration system 10 furthermore comprises a heating register 26 (also referred to as a heating condenser or heating gas cooler). A shut-off valve A3 is arranged upstream of the heating register 26. A shut-off valve A1 is arranged downstream of the heating register 26. Furthermore, an expansion valve AE4 is arranged downstream of the heating register 26.

In the scope of this description, the section from the compressor 12 to the heating register 26, to the expansion valve AE4 and to a branch Ab2 is referred to as the secondary line 16 in the entire refrigerant circuit of the refrigeration system 10. The secondary line 16 comprises a heating branch 16.1, which extends from the shut-off valve A3 via the heating register 26 to the shut-off valve A1. The secondary line 16 also includes a reheating branch or reheat branch 16.2, which is fluidically connectable to the heating register 26 upstream and to the external heat exchanger 18 downstream. The secondary line 16 or the reheat branch 16.2 opens into the primary line 14 at a branching point Ab2.

The refrigeration system 10 comprises a further evaporator or chiller 28. The chiller 28 is provided fluidically in parallel to the evaporator 22. The chiller 28 can be used, for example, to cool an electrical component of the vehicle, but also to implement a water heat pump function using the waste heat from at least one electrical component. An expansion valve AE1 is installed upstream of the chiller 28.

The refrigeration system 10 can also have an electrical heating element 30, which is designed, for example, as a high-voltage PTC heating element. The electric heating element 30 serves as an additional heater for a supply air flow L fed into the vehicle interior. The electric heating element 30 can be accommodated together with the heating register 26 and the evaporator 22 in an air conditioning unit 32. In this case, the electrical heating element 30 can be arranged downstream of the heating register 26.

The refrigeration system 10 has a sensor device pT2 arranged on the low-pressure side upstream of the refrigerant compressor 12 for detecting a first refrigerant pressure and/or a first refrigerant temperature. Furthermore, the refrigeration system 10 has a sensor device pT1 arranged on the high-pressure side downstream of the refrigerant compressor 12 for detecting a second refrigerant pressure and/or a second refrigerant temperature.

The refrigeration system 10 with heat pump function shown here as an example is intended in particular for a motor vehicle 200, which is shown here in a simplified manner as a dashed rectangle, with at least partially electric drive.

Optional check valves Rn (n=integer) are also apparent from FIG. 1. Furthermore, the refrigeration system may also have other sensor devices not shown here.

The refrigeration system 10 can be operated in different modes, which are briefly described below.

In AC operation of the refrigerant circuit 11, the refrigerant compressed to high pressure flows from the refrigerant compressor 12 into the external heat exchanger 18 with the shut-off valve A4 open. From there, it flows to the high-pressure section of the internal heat exchanger 20 and the fully open expansion valve AE3. The refrigerant can flow to the expansion valve AE2 and into the interior evaporator 22 via a branching point Ab1 (evaporator section 22.1). In parallel or alternatively, the refrigerant can flow into the chiller 28 (chiller section 28.1) via a branching point Ab4 and the expansion valve AE1. From the evaporator 22 and/or the chiller 28, the refrigerant flows on the low-pressure side into the collector 24 and through the low-pressure section of the internal heat exchanger 20 back to the compressor 12.

In AC operation, the heating branch 16.1 or the secondary line 16 is shut off by means of the shut-off valve A3, so that hot refrigerant cannot flow through the heating register 26. To retrieve refrigerant from the inactive heating branch 16.1, the shut-off element A5, which is designed as a shut-off valve, can be opened so that the refrigerant can flow in the direction of the collector 24 via the shut-off element A5 and the check valve R2, with the shut-off element A2 being closed at the same time.

In heating operation of the refrigerant circuit 11, the shut-off valve A4 is closed and the shut-off valve A3 is open, so that hot refrigerant can flow into the heating branch 16.1.

To carry out the heating function by means of the chiller 28 to implement water heat pump operation, the refrigerant compressed by means of the refrigerant compressor 12 flows into the heating register 26 via the open shut-off valve A3. At the heating register 26, heat is released to a supply air flow guided into the vehicle interior. The refrigerant then flows via the open shut-off valve A1 and the branching point Ab1. It is expanded by means of the expansion valve AE1 in the chiller 28 to absorb waste heat from electrical and/or electronic components arranged in a coolant circuit 28.2. With this heating function, the expansion valves AE3 and AE4 are closed, the shut-off valve A5 is closed, and the shut-off valve A2 is open. In this case, refrigerant displaced in water heat pump operation can be extracted via the shut-off valve A2 out of a bidirectional line 14.1 or the primary line 14 and supplied to the collector 24 via the check valve R2.

To perform the heating function by means of the external heat exchanger 18 as a heat pump evaporator, the refrigerant compressed by the refrigerant compressor 12 flows into the heating register 26 via the open shut-off valve A3 to release heat to a supply air flow L. It is then expanded via the open shut-off valve A1 by means of the expansion valve AE3 into the external heat exchanger 18 to absorb heat from the ambient air. The refrigerant then flows via a heat pump return branch 15 to the collector 24 and back to the refrigerant compressor 12. The expansion valves AE1, AE2, and AE4 remain closed, as does the shut-off valve A5.

An indirect delta connection can be implemented in that when the shut-off valve A1 is open, the refrigerant compressed by the refrigerant compressor 12 is expanded by means of the expansion valve AE1 in the chiller 28, wherein no mass flow is generated at the same time on the coolant side, i.e., in the coolant circuit 28.2, thus, for example, the fluid used as the coolant, such as water or water-glycol mixture, remains on the coolant side of the chiller 28 or coolant does not actively flow through the chiller 28. The expansion valves AE2, AE3, and AE4 remain closed in this switching variant.

In a reheating or reheat operation, the supply air flow L supplied into the vehicle interior is first cooled by means of the evaporator 22 and thus dehumidified. Using the heat transferred to the refrigerant by evaporation and dehumidification and the heat supplied to the refrigerant via the compressor 12, the supply air flow L can be completely or at least partially reheated by means of the heating register 26.

FIG. 2 shows in a simplified manner a method 500 for operating a refrigeration system 10 described above, wherein the method 500 in particular comprises the following steps.

According to a step S501, the first refrigerant pressure and/or the first refrigerant temperature are detected by means of the sensor device pT2.

According to a step S502, the second refrigerant pressure and/or the second refrigerant temperature are detected by means of the sensor device pT1.

In a step S503, a speed of the refrigerant compressor 12 is detected.

According to a step S504 a refrigerant volumetric efficiency is determined based on the pressure ratio of the first refrigerant pressure and the second refrigerant pressure and the speed of the refrigerant compressor.

According to a step S505, a refrigerant mass flow is determined based on the refrigerant volumetric efficiency determined in S504.

According to an optional step S506, a low-pressure side density of the refrigerant in a superheated region is determined based on the second refrigerant pressure and the second refrigerant temperature detected in S502.

According to a further optional step S507, a low-pressure side density of the refrigerant in a wet vapor region is determined based on the second refrigerant pressure determined in S502.

In the method 500, an assigned maximum refrigerant mass flow can be used for each operating state of the refrigeration system 10 described above, in particular cooling operation, heating operation, reheat operation, so that according to a step S508 the speed of the refrigerant compressor in the respective operating state can be limited depending on the assigned maximum refrigerant mass flow.

It is pointed out that in FIG. 2 the described steps of the method 500 are shown in a simplified sequence, even though these steps can also be carried out (in time) in parallel to one another or even simultaneously.

To carry out the method 500 described above, the refrigeration system 10 may have a control unit 50.

1. A method for operating a refrigeration system with heat pump function for a motor vehicle with at least partially electric drive, wherein the refrigeration system comprises:
a refrigerant compressor,
a first heat exchanger, in particular a gas cooler or condenser;
at least one further heat exchanger, in particular an evaporator and/or a chiller and/or a heating register;
a sensor device arranged on the low-pressure side upstream of the refrigerant compressor for detecting a first refrigerant pressure and/or a first refrigerant temperature;
a sensor device arranged on the high-pressure side downstream of the refrigerant compressor for detecting a second refrigerant pressure and/or a second refrigerant temperature, the method comprising the following steps:
detecting the first refrigerant pressure and/or the first refrigerant temperature;
detecting the second refrigerant pressure and/or the second refrigerant temperature;
detecting a speed of the refrigerant compressor;
determining a refrigerant volumetric efficiency based on the pressure ratio of the first refrigerant pressure and the second refrigerant pressure and the speed of the refrigerant compressor;
determining a refrigerant mass flow based on the refrigerant volumetric efficiency.

2. The method according to claim 1, further comprising:
determining a low-pressure side density of the refrigerant in a superheated region based on the second refrigerant pressure and the second refrigerant temperature.

3. The method according to claim 1, further comprising:
determining a low-pressure side density of the refrigerant in a wet vapor region based on the second refrigerant pressure.

4. The method according to claim 1, wherein an assigned maximum refrigerant mass flow is used for each operating state of the refrigeration system, in particular cooling operation, heating operation, reheat operation, and the speed of the refrigerant compressor in the respective operating state is limited depending on the assigned maximum refrigerant mass flow.

5. A refrigeration system having heat pump function for a motor vehicle with at least partially electric drive, wherein the refrigeration system comprises:
a refrigerant compressor,
a first heat exchanger, in particular a gas cooler or condenser;
at least one further heat exchanger, in particular an evaporator or/and a chiller or/and a heating register;
a sensor device arranged on the low-pressure side upstream of the refrigerant compressor for detecting a first refrigerant pressure and/or a first refrigerant temperature;
a sensor device arranged on the high-pressure side downstream of the refrigerant compressor for detecting a second refrigerant pressure and/or a second refrigerant temperature; and
a control unit configured to carry out the method according to claim 1.

6. The method according to claim 2, further comprising:
determining a low-pressure side density of the refrigerant in a wet vapor region based on the second refrigerant pressure.

7. The method according to claim 2, wherein an assigned maximum refrigerant mass flow is used for each operating state of the refrigeration system, in particular cooling operation, heating operation, reheat operation, and the speed of the refrigerant compressor in the respective operating state is limited depending on the assigned maximum refrigerant mass flow.

8. The method according to claim 3, wherein an assigned maximum refrigerant mass flow is used for each operating state of the refrigeration system, in particular cooling operation, heating operation, reheat operation, and the speed of the refrigerant compressor in the respective operating state is limited depending on the assigned maximum refrigerant mass flow.
